(19) United States
(12) Patent Application Publication
(10) Pub. No.: US 2001/0035990 A1
(43) Pub. Date: Nov. 1, 2001

(54) MULTIPLEXED HOLOGRAM COPYING SYSTEM AND METHOD

(76) Inventors: FAI H MOK, WEST HILLS, CA (US); YONG QIAO, ARCADIA, CA (US); GAN ZHOU, ALTADENA, CA (US); DEMETRI PSALTIS, PASADENA, CA (US)

Correspondence Address: SHELDON R. MEYER, FLIESLER, DUBB, MEYER, LOVEJOY LLP, FOUR EMBARCADERO CENTER SUITE 400, SAN FRANCISCO, CA, 941114156

(21) Appl. No.: 08/981,764

(22) PCT Filed: Jun. 21, 1996
(86) PCT No.: PCT/US96/10410

§ 371 Date: None

(51) Int. Cl. G03H 1/20

(52) U.S. Cl. 359/12

(57) ABSTRACT

A system of reproducing multiplexed holographic information from one master medium (100, 300, 400, 500, 600, 720) to another replicate medium (200, 310, 410, 510, 610, 730) simultaneously reads out the information from all multiplexed master holograms within the master medium. The replica has different phase and amplitude distributions from the master medium containing a plurality of multiplexed holograms (420, 520) though both the replica and the master contain the identical holographic information of the original objects.

### FIELD OF THE INVENTION

The present invention relates to the field of optical storage, and more specifically, to a copying system for high density and high speed optical memory based on multiplexed volume holography.

### BACKGROUND AND SUMMARY OF THE INVENTION

Information technology comprises primarily three elements: information communication, information processing, and information storage. In the past, information technology has relied on electrons as the main information carriers and electronic devices as main means for communication, processing, and storage. However, photons and optical devices are making their way into information technology related applications because of their high speed in data transferring and processing, insensitivity to electromagnetic interference, and capability of massive parallel processing. In communication systems, optical fibers are widely used for local and wide area networks and also for telecommunications. In fact, optical fibers form the backbone of many modern communication systems.

Integrated optical electronic devices based on semiconductor wafer technology and diode laser technology have been used for optical communication and optical data processing. Photonic technology is also used in applications that require massive data manipulation such as in image processing and machine vision. In information storage, optical compact discs provide high density and convenience for digital data storage at low cost.

Although superior than the electronic counterparts in many ways, optical compact discs are limited in its data accessing speed and capacity of storage for many applications. The demand for a higher density storage and high speed data access capability stimulates much research and development in data storage technology. Examples of such effort in optical storage include using shorter wavelength diode laser for compact disc systems, better digital data compression algorithm, and multilayer compact disc systems. However, the improvements brought about by these will not meet the requirements in data storage for future applications in information technology. In order to store hundreds of billions bytes of data in a CD size disc, it would require a fundamentally different approach. Optical holography is one such approach. The present invention relates to the use of optical devices for information storage and to convenient and reliable reproduction of large amount of information stored in multiplexed holograms.

Optical memory based on holography utilizes interference of coherent light to store information in the form of the amplitude and phase of light. Holographic memories can store hundreds of billions of bytes of data, transfer them at a rate of a billion or more bytes per second and select a randomly chosen data element in less than 100 microseconds. Other memory technologies can rarely offer all three of this advantages.

FIG. 1 shows the formation and reconstruction of a hologram known to the art. The holographic medium 100 is a piece of photosensitive material. The object 110 is an object whose information is to be recorded in the hologram medium 100. Two mutually coherent beams are used to form the hologram in the holographic medium 100. An object beam 120 carries the information in the object 110 to intersect with a reference beam 130 in the holographic medium 100. The reference beam 130 does not carry information and is normally a plane wave. The interference of the object beam 120 and the reference beam 130 forms interference patterns inside the holographic medium 100. The intensity variation patterns thereof are recorded by the photosensitive medium 100. Thus, a hologram containing information of the object 110 is formed inside the holographic medium 100. In order to read the information inside the hologram of holographic medium 100, a read beam is required. FIG. 1b illustrates reconstruction of the hologram. A read beam 140 that has the same wavelength and wave vector as the original reference beam 130 impinges on the holographic medium 100. The interaction of the beam 140 and the holographic grating recorded in the holographic medium 100 generates a diffracted beam 150. The diffracted beam 150, carrying the information of the object 110, propagates in the direction of the original object beam 120. A reconstructed virtual image 160 identical to the original object 110 appears at the same location where the object 110 is and can be viewed in the diffracted beam 150. The information in the hologram 100 can be two dimensional or three dimensional.

A phase matching condition, normally called Bragg condition, is required to read the information in a holographic medium. This Bragg condition requires the read beam to impinge on the holographic medium 100 at a particular angle in order to read the holographic information contained therein with maximum diffraction efficiency and optimal fidelity. Deviation from the proper Bragg angle for a specific hologram results in degraded reconstruction including reduced diffraction efficiency. For a thin holographic medium whose thickness is less than the spacing of the interference fringes in recorded holograms, this requirement in the direction of the read beam is not strict. The gratings contained in the holograms in a thin medium are said to be two dimensional. However, as the thickness of a holographic medium increases to an amount that is much larger than the fringe spacing in the holograms, the holographic gratings are formed in all directions and three dimensional volume holographic gratings are formed within the thick medium. The angular selectivity in the direction of the read beam for a particular hologram becomes more sensitive in a thick medium. The Bragg conditions of a thick holographic medium allow recording multiple images in the same volume in a holographic medium. Retrieving a particular holographic information is accomplished by illuminating the holographic grating with a read beam at a proper Bragg angle.

The above method of using the angular selectivity of a thick hologram to record multiple images in a medium is called angular multiplexing. Many other multiplexing techniques can be used to increase the information storage capacity of thick holographic media. Multiplexing techniques based on changing the angle of an incident reference beam include fractal multiplexing and peristrohpic multiplexing. Examples of other multiplexing methods are shift multiplexing, phase-code multiplexing, and wavelength multiplexing. Any one of the above multiplexing techniques or combinations thereof can be used. The properties of a holographic medium in consideration and the specific requirements of a particular application dictate the choice of multiplexing methods. For convenience of discussion, any of the multiplexing techniques mentioned above and other similar multiplexing methods including combinations thereof are referred to as “volume multiplexing” or simply “multiplexing” throughout this disclosure.

In order to maintain high fidelity in retrieving stored information in a hologram, the maximum number of images that can be stored at the same location inside the holographic medium is limited. One reason for this limitation is the limited dynamic range of the holographic medium. As more holograms share the same recording volume, the strength of each hologram diminishes. Specifically, the percentage of the light that is deflected by each hologram, i.e., the efficiency of the holographic grating, is inversely proportional to the square of the number of holograms superimposed at that location. Other factors such as cross talk by the superimposed holograms during their reading process, fluctuation of the coherent light source, scattering in the holographic medium, and detector noise can also play a role in restricting the maximum number of holograms that can be superimposed.

One method to further increase the storage capability of a holographic medium is to utilize spatial multiplexing techniques in combination with volume multiplexing methods. Multiple holograms are recorded at a plurality of spatially separate or partially overlapped locations inside a hologram medium with each location having volume multiplexed holograms. Such a double multiplexed holographic memory system can achieve high storage capacity that is not obtainable by many other non-holographic techniques. For example, the inventors of the present invention have demonstrated a system in which 10,000 data pages are stored in each of 16 locations, for a total of 160,000 holograms.

One of the advantages of optical volume holographic storage is the rapid random access by nonmechanical means. For example, high frequency acoustic waves in solids are used to deflect a reference light beam in order to select and read out a selected page of data in tens of microseconds. This is much faster than the access time of tens of milliseconds that is typical for a mechanical readout head in today's optical and magnetic discs. Clearly, optical volume holographic memories have advantages over other memory technologies in terms of storage capacity and random access time. However, one important advantage of the compact disc technology and magnetic memories is that information can be copied without any complicated system at very low cost. For example, CD-ROM and compact audio discs can be fabricated by injection molding , making them inexpensive to reproduce. In contrast, copying multiplexed holograms often involves a complicated optical system and due precaution has been required to ensure the preservation of the exact phase and amplitude information during the reproduction process.

One such holographic copying system is described by David Brady and coauthors in article “Periodically Refreshed Multiple Exposed Photorefractive Holograms” in Optics Letters, Vol. 15, pp. 817, 1990. This system copies angularly multiplexed holograms optically from one master medium to a replicate medium one by one. With a complicated 4f optical system, the exact conditions in recording the master medium is recreated at the replicate medium.

Another such system is disclosed in U.S. Pat. No. 5,339,177. As shown in FIGS. 7 and 8 in the '177 U.S. patent, the master and the replicate holographic media are placed at the conjugate image planes of the very complex imaging system. The purpose of this imaging system is to preserve the exact amplitude and phase distributions of the both writing beams, i.e., the objective beam and the reference beam, in recording of the master medium and relay them to replicate beams in recording the replicate hologram. This way the replicate hologram is identical to the original master medium in both phase information and amplitude information.

One of the disadvantages of the above two holographic copying systems is that the maximum amount of information can be copied is limited by the space-bandwidth product of the imaging optical system. In addition, such hologram copying system is sensitive to the optical alignment and thus the performance stability thereof is problematic. Further reduction in performance of these copying systems is caused by the use of multiple optical elements in the complex optical imaging system. The error from each optical element in the imaging system will contribute additionally to the overall error present in the hologram copying system. Consequently, the practicality of these systems is limited.

In recognition of the above problems in the previously described systems, the present invention discloses a hologram copying system and method for multiplexed volume holograms with improved performance, a simpler optical set-up and lower cost. The inventors of the present invention recognized the importance of the simplicity of the optical set up in a hologram copying system. The inventors recognized, importantly, that the replicate hologram must faithfully reproduce the images of the original object and the information therein, and that the replicate holograms do not necessarily have to contain the identical phase and amplitude information as the original holograms. The inventors further recognized the importance of the capability of simultaneously copying spatially multiplexed holograms with each holographic spatial unit having multiple volume multiplexed holograms.

In its simplest form, the present invention employs only one coherent read beam to duplicate a master medium to a replicate medium. This beam for duplication is substantially identical to the original reference beam used in creating the master medium in terms of beam parameters such as wavelengths, wave vectors, and phase values. The transmitted beam of the read beam will overlap and interfere with the diffracted beam from the master medium in a region and a replicate hologram is formed with replicated medium placed therein.

In the present invention, the master medium has volume multiplexed holograms and requires one read beam or multiple mutually incoherent but individually coherent read beams that satisfy the Bragg phase matching conditions for reconstruction and accordingly for duplicating the master medium to a replicate medium. In reconstructing volume multiplexed holograms, the mutually incoherent beams are necessary in order to eliminate cross-talk between superimposed gratings at the same location.

For a faithful duplication in the present invention, the replicating read beam or read beams must have a diameter that is large enough to cover the entirety of the original hologram and the diffracted object beams at the replicate holographic medium. This also allows the present invention to be able to copy multiple holograms simultaneously, which is not possible for the cited prior art systems. It is, therefore, preferential to place the replicate holographic medium close to the original master medium in order to limit the width of the read beam required and thus to reduce the power requirement for the laser source. Another advantage of placing the replicate medium close to the master medium is a simplified system and more reliable performance.

According to the present invention, the amplitude and phase distributions of the replicate hologram are different from that of the master medium since they capture different slides of the original object beam. In contrast to the prior art duplicating systems where the exact copy of the master medium is duplicated in the replicate medium, the present invention only duplicates the information from the master medium that is necessary to form the identical images of the objects that are used to produce the original master mediums. Therefore, the present invention does not require complicated, multi-element precision imaging systems that are necessary in prior art copying systems for multiplexed holograms. The much simpler setup in the present invention significantly enhances the reliability and robustness of the system and reduces the cost. Importantly, the present invention is capable of duplicating a large amount of information which has not been difficult to achieve in prior art systems due to the limited space-bandwidth product of the imaging system.

Furthermore, the distance between the master medium and the replicate medium is unimportant to faithfully copying the holographic information of a hologram in preferred embodiments of the present invention using transmission mode, whereas prior copying systems for multiplexed holograms are highly sensitive to this distance.

### BRIEF DESCRIPTION OF THE DRAWINGS

These and other features will be described with reference to the drawings, wherein:

FIG. 1 shows a basic system for recording on a master recording medium and reading out therefrom;

FIG. 2 shows a layout of a simple copying system used in the present invention, for a single beam recording;

FIG. 3 shows the first embodiment of the present invention;

FIG. 4 shows the second embodiment of the present invention;

FIG. 5 shows the third embodiment of the present invention;

FIG. 6 shows the fourth embodiment of the present invention; and

FIG. 7 shows a modification of the present invention.

### DESCRIPTION OF PREFERRED EMBODIMENTS

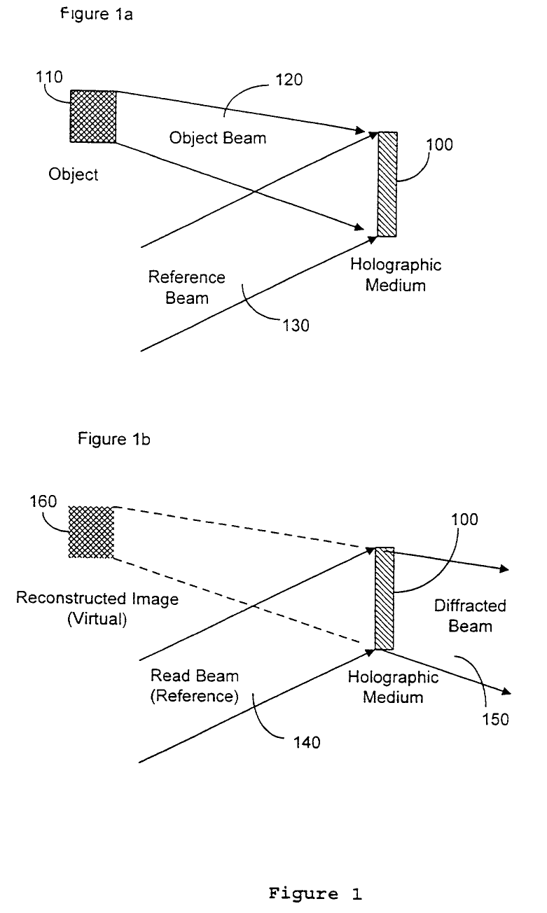

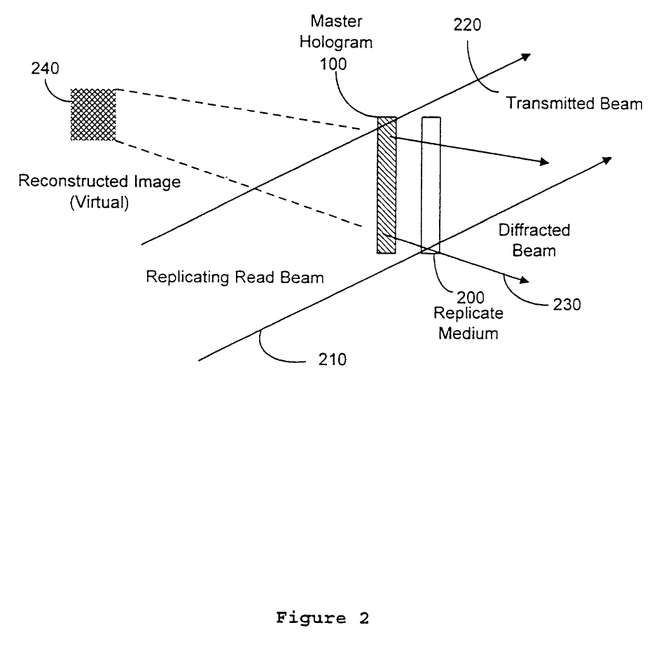

FIG. 2 illustrates the basic building blocks for copying multiple holograms in the present invention. A master medium 100 is recorded as shown in FIG. 1a. A replicating read beam 210 that is substantially similar to the original reference beam 130 of FIG. 1a is used for duplication of the master medium 100 to a replicate medium 200. The replicate medium 200 is preferably placed close to the master medium 100 although the distance between them is not critical to the implementation of the present invention. The interaction of the beam 210 and the master medium 100 produces a diffracted beam 230 that is substantially identical to the original object beam 120 on the right-hand side of the master hologram 100 in FIG. 1a. A virtual image 240 identical to the original object 110 of FIG. 1a is formed at the same location where the original object 110 is placed in recording the master medium. A portion of the replicating read beam 210 passes through the master medium 100 as the transmitted beam 220. The interference between the transmitted beam 220 and the diffracted beam 230 forms an interference optical field in a region where the two beams overlap with each other. The replicate medium 200 that is made of a photosensitive material captures the interference pattern and a copy of the master medium 100 is therefore obtained.

One notable feature of the above copying method and system is its simplicity. No complex, multi-element imaging systems are required. The position of the replicate medium 200 is flexible as long as the read beam 210 is broad enough to cover the original holographic gratings in the master medium 220 and the replicate medium 200. The space-bandwidth product of the system is large since there is no imaging optics placed between the master medium 100 and the replicate medium 200. Importantly, the holographic gratings recorded in the replicate medium 200 are different in phase and amplitude distributions from the holographic gratings contained in the master medium 100 although both contain the same information of the original object 110. Therefore, the current invention duplicates the holographic information in the master hologram without exactly copying the phase and amplitude distributions of the master hologram.

The present invention is able to duplicate multiple spatially multiplexed holograms in a master medium to a replicate medium with a read beam of broad cross-section area due to the large spatial bandwidth product of the system. To further increase the storage capability, each spatial unit thereof contain a plurality of volume multiplexed holograms. This requires a plurality of replicating read beams with each being substantially identical to the corresponding reference beams used in creating the original hologram. One unique feature of the current invention is the capability of simultaneously duplicating a large amount of holograms that are spatially multiplexed and volume multiplexed.

The inventors of the present invention have successfully demonstrated the invention with prototype copying systems. To achieve a better understanding of the underlying principles of the invention, the inventors postulate a theoretical explanation of the invention to prove that, any collection of volume multiplexed holograms recorded with a reference beam composed of a combination of plane waves can be faithfully replicated using various techniques disclosed in the present invention. The validity of the postulation should not be bounded to the embodiments and their ramifications of the present invention. A detail account of the postulation is described as follows.

It is assumed that the interference patterns of M object beams, Sⱼ, where j=1 . . . ,M, and N reference beams, are recorded in N master holograms within each location in a holographic medium. The j-th interference pattern is proportional to

$${\vert {\sum }_{i = 1}^{N} {c}_{i , j} {R}_{i} + {S}_{j} \vert}^{2} , \qquad ( 1 )$$

where Rᵢ are unit amplitude plane waves, c_{i,j} are complex constants.

In the present invention, the master holograms can be recorded with any object beams. According to the present invention, however, there is one condition on the relationship between the N plane reference beams to minimize the cross-talk between spatially superimposed holograms. Each of the N plane waves is chosen in such a way that the diffraction efficiency of the i-th hologram recorded by the corresponding i-th reference beam Rᵢ is below a predetermined small threshold that is substantially smaller than its optimal diffraction efficiency if the j-th reference beam Rⱼ different from Rᵢ (i≠j) is used for reconstruction thereof. Furthermore, Rₘ and Rₙ have the same spatial and temporal characteristics if m=n.

The corresponding hologram contained in equation (1) can be represented by

$${a}_{j} {{S}_{j} ( {\sum }_{i = 1}^{N} {c}_{i , j} {R}_{i} )}^{*} , \qquad ( 2 )$$

where aⱼ is the amplitude of the hologram. After all M holograms are recorded by multiplexing, the collection of holograms within each location is

$${\sum }_{j = 1}^{M} {a}_{j} {{S}_{j} ( {\sum }_{i = 1}^{N} {c}_{i , j} {R}_{i} )}^{*} . \qquad ( 3 )$$

During the replication process in the present invention, the holographic medium is illuminated by a collection of N plane waves that are mutually incoherent to each other, which can be represented by:

$${\sum }_{n = 1}^{N} {u}_{n} {R}_{n} exp ( j {ω}_{n} t ) \qquad ( 4 )$$

where uₙ are complex constants. The condition for mutual incoherence of two waves, Rₘ and Rₙ, can be expressed by

$$\frac{1}{T} {\int }_{T} {R}_{n} {exp ( {jω}_{n} t )}^{*} {R}_{m}^{*} exp ( - {jω}_{m} t ) ⅆ t = 0 , ( m \neq n ) \qquad ( 5 )$$

where the time constant T is much bigger than 2π/(ωₙ−ωₘ). The reconstruction beams of the holograms are given by

$${\sum }_{n = 1}^{N} {u}_{n} {R}_{n} exp ( {jω}_{n} t ) {\sum }_{j = 1}^{M} {a}_{j} {{S}_{j} ( {\sum }_{i = 1}^{N} {c}_{i , j} {R}_{i} )}^{*} . \qquad ( 6 )$$

which can be rewritten as the following:

$${\sum }_{j = 1}^{M} {\sum }_{i = 1}^{N} {a}_{j} {S}_{j} {u}_{i} {c}_{i , j}^{*} {\vert {R}_{i} \vert}^{2} exp ( {jω}_{i} t ) + {\sum }_{j = 1}^{M} {\sum }_{i = 1}^{N} {\sum }_{n \neq i }^{N} {a}_{j} {S}_{j} {u}_{i} {c}_{i , j}^{*} {R}_{n} {R}_{i}^{*} exp ( {jω}_{n} t ) . \qquad ( 7 )$$

The second term in Equation (7) is the reconstruction of the gratings SⱼRᵢ* by Bragg-mismatched plane waves Rₙ and therefore the corresponding signals are essentially zero. The first term of Equation (7) represents the reconstruction signals that satisfy the Bragg conditions. Since Rᵢ has unit amplitude, the reconstruction signals are

$${\sum }_{j = 1}^{M} {\sum }_{i = 1}^{N} {a}_{j} {u}_{i} {c}_{i , j}^{*} {S}_{j} exp ( {jω}_{i} t ) . \qquad ( 8 )$$

At the second replicate holographic medium that is located some distance away from the original hologram, the reconstructed signals can be expressed as

$${\sum }_{j = 1}^{M} {\sum }_{i = 1}^{N} {a}_{j} {u}_{i} {c}_{i , j}^{*} D ( {S}_{j} ) exp ( {jω}_{i} t ) \qquad ( 9 )$$

which factors D(Sⱼ) represent the propagation effects including phase change and Fresnel diffraction as the beams travel from the original hologram to the replicate medium. D(Sⱼ) and Sⱼ are different from each other in both amplitude and phase distributions. The transmitted reference beams are represented by

$${\sum }_{n = 1}^{N} {T}_{n} {u}_{n} {R}_{n} exp ( {jω }_{n} t ) exp ( {jφ}_{n} ) , \qquad ( 10 )$$

where Tₙ is the transmission coefficient of the original medium and φₙ is the phase change due to wave propagation.

The interference patterns formed by the reconstructed signal beams in Equation (9) and the transmitted reference beams in Equation (10) at the replicate holographic medium is

$${( {\sum }_{j = 1}^{M} {\sum }_{i = 1}^{N} {a}_{j} {u}_{i} {c}_{i , j}^{*} D ( {S}_{j} ) exp ( j {ω}_{i} t ) + {\sum }_{n = 1}^{N} {T}_{n} {u}_{n} {R}_{n} exp ( {jω}_{n} t ) exp ( j {φ}_{n} ) \vert )}^{2} \qquad ( 11 )$$

The replicate medium records the interference patterns and the corresponding holograms are proportional to

$${\sum }_{j = 1}^{M} {\sum }_{i = 1}^{N} {\sum }_{n = 1}^{N} {a}_{j} {u}_{i} {c}_{i , j}^{*} D ( {S}_{j} ) ( {u}_{n} {R}_{n} ) * exp ( - j {ϖ}_{n} t ) exp ( - j {φ}_{n} ) \qquad ( 12 )$$

where we have assumed Tₙ=T is constant for all plane waves since the holograms in the original medium share a common volume.

The recorded holograms contained in Equation (12) can be expressed as the following since the time-averaging contribution from the terms with n≠i in Equation (12) goes to zero:

$$T {\sum }_{j = 1}^{M} {\sum }_{i = 1}^{N} {a}_{j} {\vert {u}_{i} \vert}^{2} {c}_{i , j}^{*} D ( {S}_{j} ) {R}_{i}^{*} exp ( - {jφ}_{i} ) = T {\sum }_{j = 1}^{M} {a}_{j} D ( {S}_{j} ) {( {\sum }_{i = 1}^{N} {c}_{i , j} {R}_{i} {\vert {u}_{i} \vert}^{2} exp ( {jφ}_{i} ) )}^{*} . \qquad ( 13 )$$

Equation (13) represents holograms that can reconstruct the images of the original objects under illumination by proper read beams. In the special case where uᵢ is a unit complex number, Equation (13) is indicative of the recordings at the replicate medium as if the original objects were present. In comparison with the original holograms in Equation (3), the replicate holograms in Equation (13) differ from the original holograms in both phase and amplitude distributions. Another important implication thereof is that the exact location of the replicate medium relative to the original hologram is unimportant and different locations introduce different amplitude distribution D(Sⱼ) and phase φᵢ.

The above theoretical model explains the operational principles of the present invention. It shows that any holograms that are recorded with a combination of plane waves can be copied using the present invention. In particular, the present invention allows a faithful duplication of multiplexed master holograms recorded with plane reference waves if the duplicating read beams are also plane waves and preserve the same relationship as the original reference beams (e.g., a certain angle separation therebetween in angular multiplexing). If the original reference beams have a relationship relative to each other to minimize the cross-talk effect, the duplicated holograms using the present invention will have a minimized cross-talk effect as well. Otherwise, the cross-talk in the master holograms will be also copied in the duplicated holograms in the present invention. Furthermore, it shows that the copied holograms in the present invention are different from the originals but the holographic information thereof is identically replicated.

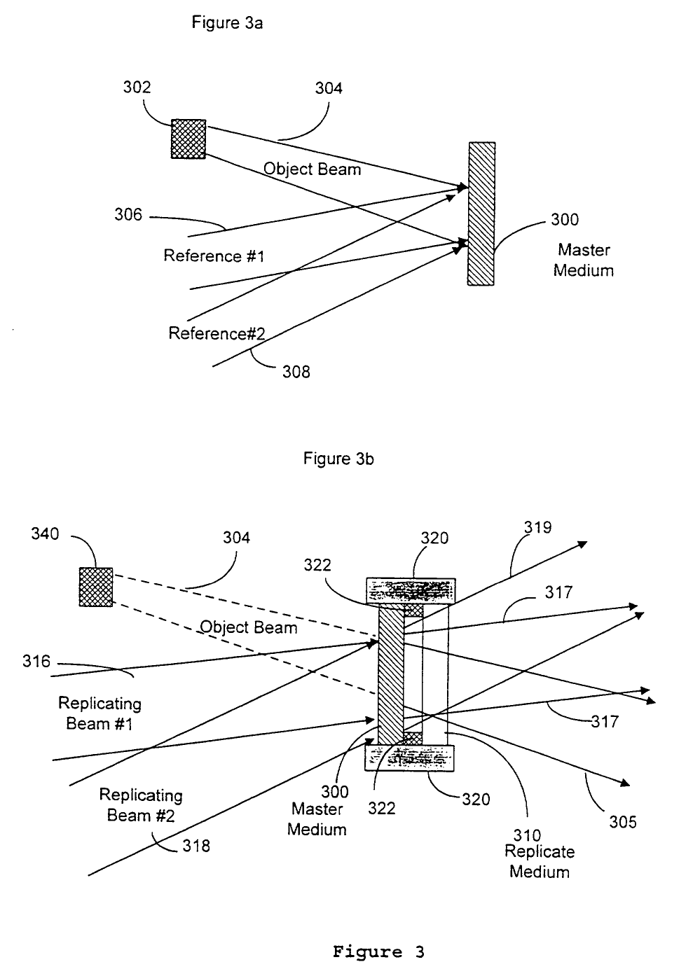

FIG. 3 shows the first embodiment of the present invention for duplicating volume multiplexed holograms. A master medium 300 contains a plurality of volume multiplexed holograms. The volume multiplexing technique can be any one selected from a group comprising angular multiplexing, fractal multiplexing, peristrohpic multiplexing, shift multiplexing, phase-code multiplexing, wavelength multiplexing, and any combination thereof. Detailed descriptions of these multiplexing techniques are given in the following references:

Angular multiplexing, F. H. Mok, M. C. Tackitt, and H. M. Stoll, “Storage of 500 high-resolution holograms in a LiNbO3 crystal,” Optics Letters, Vol.16, pp.605, 1991;

Phase-code multiplexing, Y. Taketomi, J. Ford, H. Sasaki, J. Ma, Y. Fainman, and S. H. Lee, “Multimode operations of a holographic memory using orthogonal phase codes,” in Technical Digest on Photorefractive Materials, Effects, and Devices, 1991 (Optical Society of America, Washington, D.C., 1991),Vol.14, pp 126-129;

Wavelength multiplexing, G. A. Rakuljic, V. Leyva, and A. Yariv, “Optical data storage by using orthogonal wavelength-multiplexed volume holograms,” Optics Letters, Vol.17, pp.1471, 1992;

Fractal multiplexing, F. H. Mok, “Angle-multiplexed storage of 5000 Holograms in lithium niobate”, Optics Letters, Vol.18(11), pp.915-917, 1993;

Shift multiplexing, D. Psaltis, M. Levene, A. Pu, G. Barbastathis, and K. Curtis, “Holographic storage using shift multiplexing”, Optics Letters, Vol.20(7), pp.1, 1995; and

Peristrophic multiplexing, K. Curtis, A. Pu, and D. Psaltis, “Method for holographic storage using peristrophic multiplexing”, Optics Letters, Vol.19(13), pp.993-994, 1994.

In recording the master medium 300, an object data input module 302 is employed to update the object images in accordance with different reference beams. Two reference beams, 306 and 308, are shown in FIG. 3a to represent a plurality of reference beams used in recording the master medium 300. The optical beams for both recording the master medium 300 or duplicating the replicate 310 are generated either by a single laser or a plurality of lasers including diode lasers, laser diode arrays, and diode-pumped solid-state lasers. The object input module 302 can be a real object or a spatial light modulator.

The first hologram is recorded as follows. The object module 302 inputs the first object image via the object beam 304. In absence of all other reference beams except in recording phase-code multiplexed holograms, the first reference beam 306 that is coherent with the object beam 304 is directed to the master recording medium 300. The master medium 300 captures the interference pattern of the object beam 304 imprinted with the first object image and the first reference beam 306. The object module 302 replaces the first object image with the second object image which is imprinted onto the object beam 304.

A second reference beam 308, having a different relationship with the first reference beam 306 in terms of volume multiplexing (e.g., incident angle, wavelength, etc.), is directed to the master recording medium 300 without the presence of any other reference beams. In recording angularly multiplexed holograms, for example, the second reference beam 308 is incident at an angle at which the diffraction efficiency of the first hologram for second reference beam 308 is substantially reduced and below a predetermined small threshold value. In wavelength multiplexing, the second reference beam 308 is at a different wavelength from the first reference beam 306 that the diffraction efficiency of the second reference beam 308 from the first hologram grating is substantially reduced and below a predetermined small threshold value. The hologram of the second object is therefore recorded in the same recording volume or superimposed with the first hologram. Therefore, each multiplexed hologram is associated with a reference beam with a characteristic unique to that multiplexed hologram. The above recording procedure is repeated until all volume multiplexed holograms are superimposed in the same volume inside the master recording medium. Recording of the master medium 300 is then completed.

In recording phase-code multiplexed master holograms, each multiplexed hologram is recorded with multiple reference beams. The phase-code of every set of reference beams is orthogonal to other sets used in recording.

FIG. 3b illustrates the duplication process. A sample stage 320 holds the master medium 300 and a replicate medium 310 close together and ensures the mechanical stability of the media during the recording process. A plurality of replicating read beams corresponding to the original writing reference beams are used for duplicating the master medium 300 to the replicate medium 310. Two replicating read beams, 316 and 318, are shown therein as examples. The replicating read beams are substantially identical to their corresponding writing reference beams except they can have larger cross-section area in order to cover the entire replicate medium 310 for a faithful copy. In particular, the replicating read beams preserve the relative relationship between the original reference writing beams. Therefore, each replicating read beam processes a characteristic uniquely associated with one of the multiplexed holograms stored in the master medium 300. This beam characteristic can be the frequencies, wave vectors, relative phases, and other parameters of the replicating beams or any combination thereof. For example, one such characteristic in a replicating read beam can be the incident angle associated with a particular angularly multiplexed hologram. In another example, the wavelength of a replicating read beam is one such beam characteristic uniquely associated with a particular wavelength multiplexed hologram. In particular, Bragg phase-matching condition is satisfied for angular multiplexed holograms since the wave vector and wavelength of a replicating read beam is the same as its corresponding writing reference beam in making an angularly multiplexed master hologram.

As mentioned earlier, the replicate medium 310 is preferably close to the master medium 300 for duplication. An optional spacer 322 is shown in FIG. 3b for maintaining a small spacing between the master medium 300 and the replicate medium 310 and ensuring mechanical stability in conjunction with a sample holding stage 320. Moreover, the replicate medium 310 can be held against the master medium 300 on the sample stage 320 without the optional spacer 322.

A replicate hologram is produced by exposing a piece of unexposed holographic medium 310 simultaneously to the replicating read beams, 316, 318, etc. The interference patterns between the diffracted beams and the transmitted beams are recorded and further processed.

Importantly, the exact order to which the multiplexed master holograms are recorded is not important as far as the replicating process described in the present invention is concerned. The hologram duplicating system and method of the present invention will work with a set of multiplexed holograms recorded in a master medium by any multiplexing techniques as long as the relationship between the plane reference writing beams are preserved in the replicating beams.

As described earlier, some advantages of present invention include the ability to duplicating a large amount of holographic information simultaneously, capability of spatial and volume multiplexing of volume holograms, simple optical system, and easy operation. As shown in FIG. 3, the transmission copying scheme used in the present invention is relatively insensitive to vibrations and the spacing between the master medium 300 and the replicate medium 310. Any phase changes introduced to the replicating read beams, 316, 318, etc., are automatically transmitted to the phase of the reconstructing diffracted beams. Consequently, the phase differences between the writing beams at the replicate medium 310 remains constant.

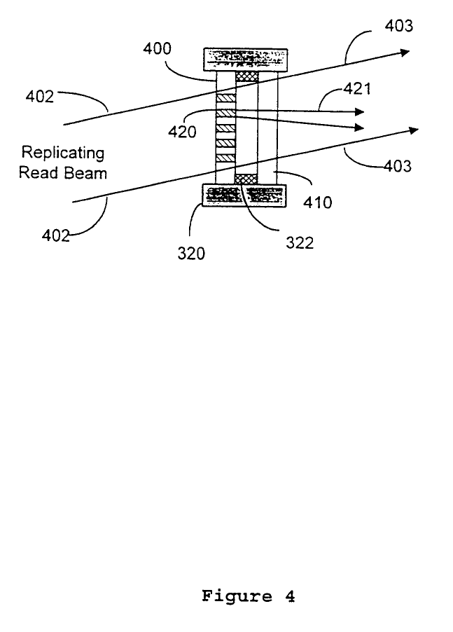

FIG. 4 shows the second embodiment of the present invention for duplicating spatially multiplexed holograms. A master holographic medium 400 contains a plurality of spatial units with two adjacent units having no or partial overlap with each other. Each spatial unit is recorded with a hologram containing holographic information of an object image. All holograms in the master 400 are recorded with reference writing beams having the same beam characteristics such as wavelengths, wave vectors, and relative phases. In duplicating the master medium 400, an unexposed replicate holographic medium 410 is placed on a sample stage 320. The replicate medium 410 is preferably close to the master medium 400 for duplication. An optional spacer 322 is shown in FIG. 4 for maintaining a small spacing between the master medium 400 and the replicate medium 410 and ensuring mechanical stability. Moreover, the replicate medium 410 can be held against the master medium 400 on the sample stage 320 without the optional spacer 322.

A replicating read beam 402 substantially identical to the original reference beams in beam characteristics such as frequencies, wave vectors, and relative phases is used for duplication. However, the replicating read beam 402 has a broader cross-section than that of the original reference beams to illuminate all the spatial holographic units in the master medium 400 and the recording portion of the replicate medium 410 that is illuminated by the diffracted beams and transmitted beam 403. This is to ensure that the copied holograms in the replicate medium 410 have high fidelity to the master medium 400.

A plurality of interference patterns between the transmitted replicating beam 403 and a plurality of diffracted beams (e.g., beam 421) from each spatial holographic unit (e.g., unit 420) are recorded in the replicate medium 410 simultaneously. The phase and amplitude distributions of the replicated holograms in the replicate medium 410 are different form the master holograms in the master medium 400 but both contain the same information of the original objects.

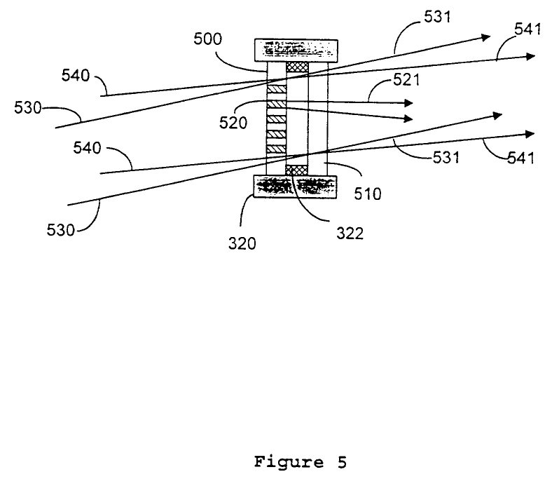

FIG. 5 is the third embodiment of the present invention. A master medium 500 contains a plurality of spatial units with two adjacent units having no or partial overlap with each other. Each spatial unit is recorded with a plurality of holograms using volume multiplexing techniques and any combination thereof. Suppose there are P spatial units and each unit has Q volume multiplexed holograms. The total number of holograms stored is given by PQ. Such “double multiplexing” used in the present invention significantly increases the storage capability of holographic memories.

In creating the multiplexed master holograms in the master medium 500, P objective beams imprinted with a first set of P images out of PQ images are used to illuminate P spatial units in the master holographic medium, respectively. For this first set of P images, the same volume multiplexing technique is used for all P spatial units in recording the corresponding holograms. A reference beam in coherence with all P objective beams has a large cross-section area to illuminate the portion of the master holographic medium illuminated by P objective beams. The interference of the broad reference writing beam and P objective beams form P holograms in P spatial units. Alternatively, a narrow reference beam in coherence with the objective beams can be used to record the master holograms in each spatial unit one by one. Recording of the first P holograms in P spatial units is thus completed.

A second set of P objective beams carrying a different set of P images out of the remaining P(Q-1) images are sent to the P spatial units, respectively. Again, a second volume multiplexing technique is applied to record P holograms in the P spatial units, respectively. However, this second volume multiplexing technique is not necessarily the same as the first volume multiplexing technique used in recording the first set of P holograms therein. A second broad cross-section reference writing beam interferes with the second set of P objective beams to form a second set of P holograms in the P spatial units. Alternatively, a second narrow cross-section reference writing beam can be used to record the second set of P holograms in each spatial unit one by one. The second reference writing beam can have different beam characteristics (e.g., wavelength, wave vector, etc.) from the first reference writing beam depending on the second volume multiplexing technique used. Repeat the above processes to record the remaining P(Q-2) images.

Importantly, the exact order to which the multiplexed master holograms are recorded is not important as far as the replicating process described in the present invention is concerned. The hologram duplicating system and method of the present invention will work with a set of multiplexed holograms recorded in a master medium by any multiplexing techniques as long as the relationship between the plane reference writing beams are preserved in the replicating beams.

For duplication of the above double-multiplexed holograms in the master medium 500, P mutually incoherent but individually coherent replicating read beams are used. One or a plurality of coherent light sources can be used including diode lasers, diode laser arrays, and diode-pumped solid-state lasers. Two replicating read beams, 530 and 540, are shown in FIG. 5 as examples. The replicating beams have substantially identical beam characteristics (e.g., wavelength and wave vector) to the original reference beams, respectively. Therefore, each replicating read beam processes a characteristic uniquely associated with one of the multiplexed holograms stored in the master medium 300. As described earlier, for example, one such characteristic in a replicating read beam can be the incident angle associated with a particular angularly multiplexed hologram. In another example, the wavelength of a replicating read beam is one such beam characteristic uniquely associated with a particular wavelength multiplexed hologram. In addition, the cross-sections of the read beams are bigger than those of the reference beams for faithful duplication as described previously therein.

The master medium 500 and the replicate medium 510 are held close to each other on a sample stage 320. An optional spacer 322 is shown in FIG. 5. Importantly, the implementation of the present invention allows an arbitrary spacing between the master medium 500 and the replicate medium 510. In particular, the master medium 500 can be held against the replicate medium 510 on the sample stage 320 without the optional spacer 322.

In forming the duplicated holograms in the replicate medium 510, each of Q transmitted replicating read beam (e.g., beam 531 from beam 530 or beam 541 from beam 540) interferes with P diffracted beams resulted from the interaction of Q mutually incoherent replicating read beams and a total of PQ holographic gratings in the master medium 500. As shown in FIG. 5, a spatial unit 520 in the master medium 500 contains Q volume multiplexed holograms which simultaneously interact with all Q replicating read beams 530, 540, etc., respectively. All P spatial units are undergoing the same process at the same time. Hence a total of PQ holograms will be duplicated in the replicated medium 510 simultaneously. Similar to the master medium 500, the replicate medium 510 will also have P spatial units with each having Q volume multiplexed holograms. Unlike the master medium 500, the duplicated holograms in the replicate medium 510 have different phase and amplitude distributions from the corresponding original holograms as described earlier.

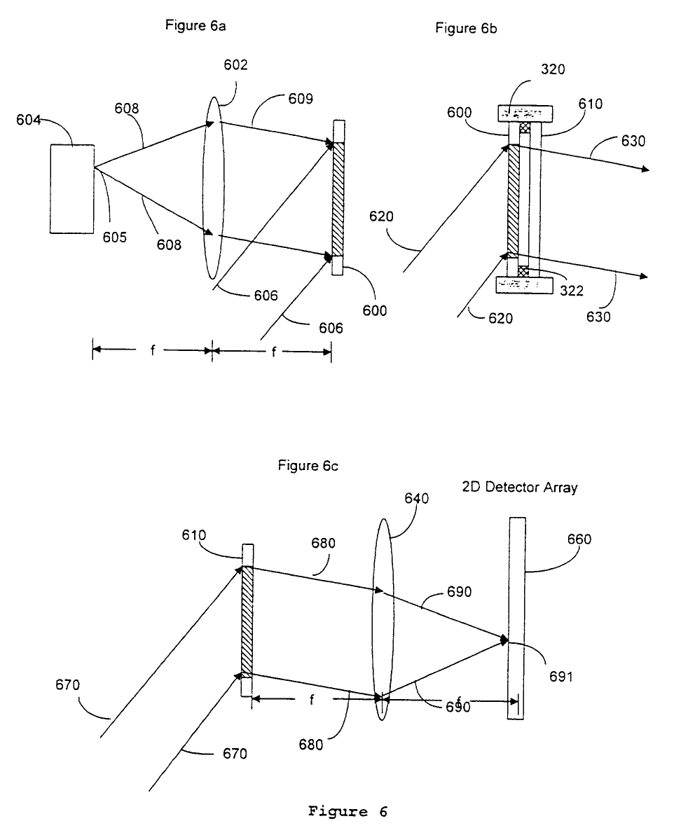

A fourth embodiment of the present invention is illustrated in FIG. 6. In both creating the master medium 600 and reconstructing the replicate hologram 610, an identical Fourier lens is used. FIG. 6a shows the recording process of the master hologram. A spatial light modulator (SLM) 604 is used to imprint either an image of a real object or a computer generated pattern to a coherent beam. A Fourier lens 602 is placed at a distance equal to the focal length from the SLM 608. A recording medium for the master hologram is on the other side of the lens 602 at a distance of focal length. In this setup, the input image on the SLM 604 is Fourier-transformed to the Fourier plane wherein the master recording medium is located.

In particular, each spatial component of the object wave emitted by the input image in the SLM 604 is transformed into a plane wave by the Fourier lens 602. High spatial frequency components containing information of the fine features in the image are transformed into plane waves having large angles with respect to the optic axis of the Fourier lens 602. A reference beam 606 interferes with all the plane object beams (e.g., beam 609) and the corresponding interference patterns are recorded. After further processing, a mater hologram 600 is obtained. The reference beam 606 can have any wavefront but a plane wave is preferred. Using a plane wave for the reference beam 606, the Fourier holograms in the master medium 600 are plane-wave gratings. Spatial multiplexing, volume multiplexing techniques, or any combination thereof is used to store a plurality of images in the master medium 600 as described in other preferred embodiments.

Importantly, the exact order to which the multiplexed master holograms are recorded is not important as far as the replicating process described in the present invention is concerned. The hologram duplicating system and method of the present invention will work with a set of multiplexed holograms recorded in a master medium by any multiplexing techniques as long as the relationship between the plane reference writing beams are preserved in the replicating beams.

FIG. 6b shows the duplicating process similar to the systems described in other embodiments. A sample stage 320 holds the master medium 600 and a replicate medium 610 close together. An optional spacer 322 is shown to maintain a constant small spacing between the media. As described earlier, an arbitrary spacing between the master medium 600 and the replicate medium 610 is allowed in the present invention. In particular, the master medium 600 can be held against the replicate medium 610 on the sample stage 320 without the optional spacer 322. At least one replicating read beam (e.g., beam 620) corresponding to the original reference beam (e.g., beam 606) is used for duplication. An unexposed replicate medium 610 records the interference patterns between the transmitted replicating beams and the diffracted beams (e.g., beam 630) from the master medium 600. All multiplexed holograms in the master medium 600 are duplicated to the replicate medium 610 simultaneously.

In reading the multiplexed holograms in the replicate hologram 610, a Fourier lens 640 substantially identical to the lens 602 is used as shown in FIG. 6c. The replicate hologram 610 is placed in a first Fourier plane of the lens 640 and a photodetector array 660 is placed in a second Fourier plane thereof. Shown in FIG. 6, an image pixel 605 in the SLM 604 is reconstructed using a replicate hologram 610 at an appropriate pixel 691 on the detector array 660.

Although only a few embodiments have been described in detail, those having ordinary skill in the art should understand that the preferred embodiments herein are intended to exemplify the spirit of the present invention and by no means should be construed to limit the present invention to the particularities described thereof. Many modifications are possible in the preferred embodiments without departing from the teachings thereof.

For example, the present invention can be applied to duplicate multiplexed holograms using reflection mode instead of transmission mode. The replicate medium is placed in between the master hologram and the laser sources in the reflection mode. In implementing the present invention for reflection holograms, however, the spacing between the master medium and the replicate medium cannot be arbitrarily large and is limited within to the half of the coherence length of the laser sources that generate the replicating read beams. This is to ensure the stability of the interference patterns to be recorded at the replicate medium.

In duplicating multiplexed holograms in a master holographic medium, collimating optics may be used to convert a laser beam from each laser source into a plane wave. The collimating optics can be one or a plurality of lenses including lens array, one or a plurality of curved mirrors, one or a plurality of diffractive optical elements including an array of diffractive optic elements, or a combination of any these elements.

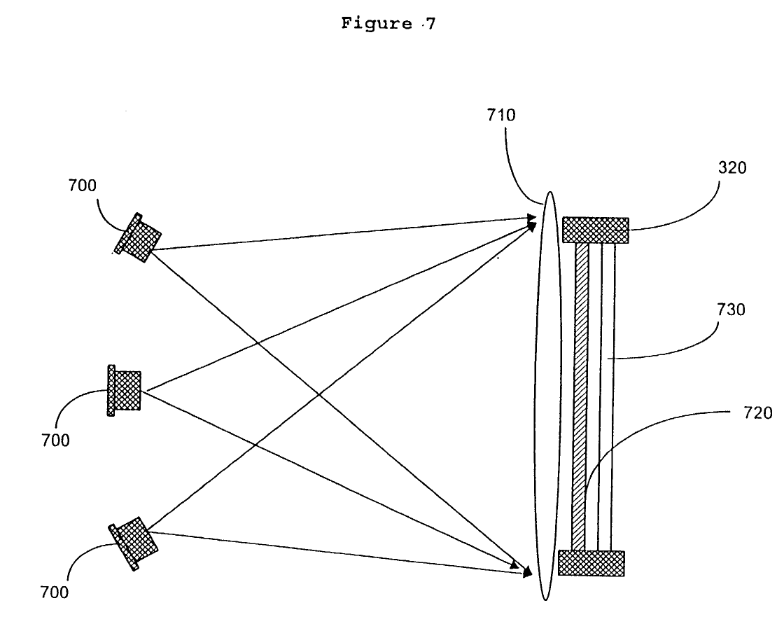

Furthermore, the laser sources for the present invention can be a variety of lasers to the appropriate wavelengths and beam characteristics for a specific application. Laser diode based laser systems are preferred for their compactness and ease of use and maintenance comprising diode lasers, diode laser arrays, diode pumped solid-state lasers including diode pumped fiber lasers, and any combination thereof. FIG. 7 shows one such example in which a replicating system for angular and peristrophic multiplexed holograms using diode lasers based on the present invention. The laser diodes (e.g., laser diode 700) are positioned such that their emissions are collimated by a single lens 710 into plane waves which satisfy the Bragg-matching conditions the angle multiplexed holograms recorded in the master medium 720. The number of laser diodes is equal to the number of multiplexed holograms in the master medium 710. One variation for the system in FIG. 7 is that the single collimating lens 710 is eliminated. Instead, a plurality of collimating optical elements are placed in front of the laser diodes 700. Each collimating optical element can be integrated with a laser diode 700 in a single package.

All these and other modifications and variations are intended to be encompassed within the following claims, in which:

What is claimed is:

1. A system of copying information from multiplexed master holograms recorded in a master medium to a replicate photosensitive medium, comprising:
a holding structure, operating to hold said master medium and said replicate photosensitive medium;
a plurality of individually coherent but mutually incoherent replicating light beams, each having a beam characteristic unique to one of said multiplexed master holograms, said replicating light beams being broad enough to illuminate both said multiplexed master holograms in said master medium and a recording area on said replicate photosensitive medium;
said replicating light beams interacting with said multiplexed master holograms to produce diffracted beams therefrom;
said diffracted light beams interfering with a portion of said replicating light beams to produce interference patterns in said replicate photosensitive medium; and
said replicate photosensitive medium operating to record said interference patterns therein.

2. A system as in claim 1, wherein said multiplexed master holograms in said master medium are produced by a multiplexing system selected from a group comprising angular multiplexing, fractal multiplexing peristrophic multiplexing, shift multiplexing, phase-code multiplexing, wavelength multiplexing, and a combination thereof; and
accordingly, said unique beam characteristic in each one of said replicating read beams is a component from one of said multiplexed systems.

3. A system as in claim 1, wherein said plurality of individually coherent and mutually incoherent replicating read beams are produced by at least one of coherent light sources including diode lasers, or diode laser arrays, or diode-pumped solid-state lasers, or a combination thereof.

4. A system as in claim 3, further including a collimating lens placed in a vicinity of said master medium and located between said coherent light sources and said master medium, said collimating lens operating to collimate light beams emitted by said coherent light sources.

5. A system as in claim 3, further including a collimating optical element in each one of said coherent light sources, said collimating optical element operating to collimate light beams emitted from said coherent light sources.

6. A system as in claim 1, wherein said multiplexed master holograms are recorded by interfering Fourier transforms of a plurality of object images with a plurality of plane-wave reference writing beams.

7. A system as in claim 6, wherein said multiplexed master holograms in said master medium are produced by a multiplexing system selected from a group comprising angular multiplexing, fractal multiplexing, peristrophic multiplexing, shift multiplexing, phase-code multiplexing, wavelength multiplexing, and a combination thereof; and
accordingly, said unique beam characteristic in each one of said replicating read beams is a component from one of said multiplexed systems.

8. A system as in claim 1, wherein said portion of said replicating light beams is a part of said replicating light beams that transmit through said master medium and impinge on said replicate medium.

9. A system as in claim 8, wherein said multiplexed master holograms in said master medium are produced by a multiplexing system selected from a group comprising angular multiplexing, fractal multiplexing peristrophic multiplexing, shift multiplexing, phase-code multiplexing, wavelength multiplexing, and a combination thereof; and
accordingly, said unique beam characteristic in each one of said replicating read beams is a component from one of said multiplexed systems.

10. A system as in claim 1, wherein said replicating light beams diffract from said multiplexed master holograms in a reflective way.

11. A system as in claim 10, wherein said multiplexed master holograms in said master medium are produced by a multiplexing system selected from a group comprising angular multiplexing, fractal multiplexing peristrophic multiplexing, shift multiplexing, phase-code multiplexing, wavelength multiplexing, and a combination thereof; and
accordingly, said unique beam characteristic in each one of said replicating read beams is a component from one of said multiplexed systems.

12. A system as in claim 1, wherein said holding structure holds said master medium against said replicate photosensitive medium.

13. A system of copying information from spatially multiplexed master holograms recorded in a master medium to a replicate photosensitive medium, comprising:
a holding structure, operating to hold said master medium and said replicate photosensitive medium;
said spatially multiplexed master holograms, each located in a spatial unit in said master medium having no or partial spatial overlap with neighboring spatial units, and each being recorded using reference writing beams substantially identical to each other;
a coherent replicating light beam substantially identical to said reference writing beams, said replicating light beam being broad enough to illuminate all said spatial units in said master medium and a recording area on said replicate photosensitive medium;
said replicating light beam interacting with each one of said spatially multiplexed master holograms simultaneously to produce diffracted beams therefrom;
said diffracted light beams interfering with a portion of said replicating light beams to produce interference patterns In said replicate photosensitive medium; and
said replicate photosensitive medium operating to record said interference patterns in a plurality of spatial units therein, respectively.

14. A system as in claim 1, wherein said multiplexed master holograms are recorded and spatially superimposed in a recording volume within said master medium and accordingly replicated holograms in said replicate medium are spatially superimposed.

15. A system as in claim 14, wherein said multiplexed master holograms in said master medium are produced by a multiplexing system selected from a group comprising angular multiplexing, fractal multiplexing, peristrophic multiplexing, shift multiplexing, phase-code multiplexing, wavelength multiplexing, and a combination thereof; and
accordingly, said unique beam characteristic in each one of said replicating read beams is a component from one of said multiplexed systems.

16. A system as in claim 15, wherein said multiplexed master holograms are recorded by interfering Fourier transforms of a plurality of object images with a plurality of plane-wave reference writing beams.

17. A system as in claim 15, wherein said portion of said replicating light beams is a part of said replicating light beams that transmit through said master medium and impinge on said replicate medium.

18. A system as in claim 15, wherein said replicating light beams diffract from said multiplexed master holograms in a reflective way.

19. A system of copying information from multiplexed master holograms in a master medium to a replicate photosensitive medium, comprising:
a holding structure, operating to hold said master medium and said replicate photosensitive medium;
said master medium having a plurality of spatial units spatially separated or partially overlapped with each other in said master medium, each said spatial unit having a plurality of multiplexed master holograms spatially superimposed therein;
a plurality of individually coherent but mutually incoherent replicating light beams, each having a characteristic unique to one of said multiplexed master holograms, said replicating light beams being broad enough to illuminate all said spatial units in said master medium and a recording area on said replicate photosensitive medium;
said replicating light beams interacting with said multiplexed master holograms in each and every said spatial units to produce diffracted beams therefrom;
said diffracted light beams interfering with a portion of said replicating light beams to produce interference patterns in said replicate photosensitive medium; and
said replicate photosensitive medium operating to record said interference patterns in a plurality of spatial units therein.

20. A system as in claim 19, wherein said multiplexed master holograms in said master medium are produced by a multiplexing system selected from a group comprising angular multiplexing, fractal multiplexing, peristrophic multiplexing, shift multiplexing, phase-code multiplexing, wavelength multiplexing, and a combination thereof; and
accordingly, said unique beam characteristic in each one of said replicating read beams is a component from one of said multiplexed systems.

21. A system as in claim 20, wherein said multiplexed master holograms are recorded by interfering Fourier transforms of a plurality of object images with a plurality of plane-wave reference writing beams.

22. A system as in claim 20, wherein said portion of said replicating light beams is a part of said replicating light beams that transmit through said master medium and impinge on said replicate medium.

23. A system as in claim 20, wherein said replicating light beams diffract from said multiplexed master holograms in a reflective way.

24. A system as in claim 2, wherein said multiplexed master holograms being recorded with a plurality of plane-wave reference beams.

25. A system as in claim 24, further including:
said plane-wave reference beams having a relationship relative to each other, said relationship operating to minimize cross-talk between said multiplexed master holograms;
said plane-wave replicating beams preserving said relationship of said plane-wave reference beams and operating to record duplicated holograms in said replicate medium; and
whereby said duplicated holograms having minimized cross-talk therebetween.

26. A method of copying information from multiplexed master holograms recorded in a master medium to a replicated photosensitive medium, comprising:
maintaining said master medium and said replicate photosensitive medium relative to each other;
producing a plurality of individually coherent but mutually incoherent replicating light beams, each having a beam characteristic unique to one of said multiplexed master holograms and being broad enough to illuminate both said multiplexed master holograms in said master medium and a recording area on said replicate photosensitive medium;
illuminating said multiplexed master holograms with said replicating light beams to produce diffracted beams therefrom; and
recording interference patterns of said diffracted light beams and a portion of said replicating light beams in said replicate photosensitive medium.

27. A method as in claim 26, wherein said multiplexed master holograms in said master medium are produced by a multiplexing method selected from a group comprising angular multiplexing, fractal multiplexing peristrophic multiplexing, shift multiplexing, phase-code multiplexing, wavelength multiplexing, and a combination thereof; and
accordingly, said unique beam characteristic in each one of said replicating read beams is a component from one of said multiplexed methods.

28. A method as in claim 26, wherein said multiplexed master holograms are recorded by interfering Fourier transforms of a plurality of object images with a plurality of plane-wave reference writing beams.

29. A method as in claim 26, wherein said portion of said replicating light beams is a part of said replicating light beams that transmit through said master medium and impinge on said replicate medium.

30. A method as in claim 26, wherein said replicating light beams diffract from said multiplexed master holograms in a reflective way.

31. A method of copying information from multiplexed master holograms in a master medium to a replicate photosensitive medium, said master medium having a plurality of spatial units spatially separated or partially overlapped with each other in said master medium, each said spatial unit having a plurality of multiplexed master holograms spatially superimposed therein, comprising:
maintaining said master medium and said replicate photosensitive medium relative to each other;
producing a plurality of individually coherent but mutually incoherent replicating light beams, each having a characteristic unique to one of said multiplexed master holograms, said replicating light beams being broad enough to illuminate all said spatial units in said master medium and a recording area on said replicate photosensitive medium;
illuminating said multiplexed master holograms in each and every said spatial units in said master medium with said replicating light beams to produce diffracted beams therefrom; and
recording interference patterns of said diffracted beams and a portion of said replicating light beams in a plurality of spatial units in said replicate photosensitive medium.
